(19) United States
(12) Patent Application Publication
(10) Pub. No.: US 2026/0181292 A1
(43) Pub. Date: Jun. 25, 2026

(54) EMULATING NON-DISCERNIBLE PASSIVE OPTICAL NETWORK INTERFERENCE

(71) Applicant: Verizon Patent and Licensing Inc., Basking Ridge, NJ (US)

(72) Inventors: Denis A. Khotimsky, Westborough, MA (US); Zigmunds A. Putnins, Ridgewood, NJ (US); David J. Baker, Mechanicsville, VA (US)

(21) Appl. No.: 19/000,873

(22) Filed: Dec. 24, 2024

(51) Int. Cl. H04Q 11/00

(52) U.S. Cl. CPC H04Q 11/0067; H04Q 11/0005; H04Q 2011/0015; H04Q 2011/0049; H04Q 2011/0083; H04Q 2011/0086

(57) ABSTRACT

An example method includes dividing an optical communication channel to separate an upstream path and a downstream path, generating an interference signal to emulate rogue transmission behavior on the upstream path by connecting the downstream path to the upstream path, and undividing the optical communication channel, after generating the interference signal, by recombining the downstream path and the upstream path.

### BACKGROUND

A passive optical network (PON) system uses an optical distribution network (ODN) to provide connectivity between a central node known as an Optical Line Termination (OLT) and a number of premises nodes (known equivalently as Optical Network Units (ONUs) or Optical Network Terminals (ONTs)) using bi-directional wavelength channels. A PON protocol (associated with a PON system) promotes precisely timed transmission bursts of individual ONUs towards the OLT so that they do not interfere with each other.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is a diagram of a communication system, according to some embodiments.

FIGS. 2A, 2B, and 2C are transmission timing diagrams, according to some embodiments.

FIGS. 3 and 4 are diagrams of rogue optical network unit emulators, according to some embodiments.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

The following provides a discussion of some types of scenarios in which the disclosed subject matter may be utilized and/or implemented.

According to some embodiments, an example method includes dividing an optical communication channel to separate an upstream path and a downstream path, generating an interference signal to emulate rogue transmission behavior on the upstream path by connecting the downstream path to the upstream path, and undividing the optical communication channel, after generating the interference signal, by recombining the downstream path and the upstream path.

In a single-wavelength, time division multiplexing (TDM)/ time division multiple access (TDMA) passive optical network (PON) system (e.g., ITU-T G.984 G-PON, G.987 XG-PON, or the like), an optical network unit (ONU) operates over a single, fixed wavelength channel associated with a particular optical line terminal channel termination (OLT CT) over a single optical distribution network (ODN). The TDM/TDMA system can include a single OLT CT and multiple ONUs interconnected by an ODN that includes an optical feeder fiber (also known as a trunk fiber), a splitter, and multiple distribution fibers. The TDM/TDMA PON system can operate over a single bi-directional wavelength channel, where the bidirectional wavelength channel can include a fixed downstream wavelength and a fixed upstream wavelength. The ONUs can support the same fixed downstream wavelength and the same fixed upstream wavelengths.

Once a particular ONU is activated on the TDM/TDMA PON system, the particular ONU can interact with a unique OLT channel termination. Prior to transmitting upstream in the TDM/TDMA PON system, the particular ONU can be required to learn parameters (e.g., burst profile parameters) of an upstream burst (e.g., a preamble, delimiter sizes and patterns, or the like) that the OLT CT provides in a downstream broadcast management message. For example, the ONU can enter a synchronization stage of an activation cycle. While in the synchronization stage, the ONU can attain synchronization to a downstream signal and learn system, channel, and/or burst profile parameters via downstream transmission from the OLT CT.

As used herein, a transmission (e.g., a downstream transmission and/or an upstream transmission) can refer to an act of transmitting an optical signal or signals over the fiber by a transmitter (e.g., a downstream transmission provided by an OLT CT toward an ONU(s) or an upstream transmission provided by an ONU toward an OLT CT). Additionally, as used herein, a downstream optical signal can refer to the continuous sequence of fixed-size physical frames transmitted by the OLT CT. Additionally, as used herein, an upstream burst can refer to a single time-bounded optical signal transmitted by an ONU.

In a time and wavelength division multiplexing (TWDM) PON system, an ONU can operate on multiple wavelength channels (e.g., one wavelength channel at a time). Each wavelength channel can be associated with a corresponding OLT CT, and the multiple wavelength channels can be multiplexed over a single ODN. The OLT CTs that form the TWDM PON system can physically belong to the same module within a single OLT, to different modules within a single OLT, or to different OLTs.

The multiple ONUs in a TWDM PON system can operate on a particular wavelength channel at any given time and can utilize TDM/TDMA mechanisms. An ONU in a TWDM PON system can be instructed by the OLT CT to switch from an original wavelength channel to a new wavelength channel. When the OLT CT provides such instructions, the ONU can leave multiple ONUs associated with the original wavelength channel, can retune an optical transceiver to specified downstream and upstream wavelengths, and can join multiple ONUs associated with the new wavelength channel.

When an ONU is newly activated or reactivated on a TDM/TDMA PON system, the ONU can enter a discovery stage of an activation cycle. While in the discovery stage, the ONU can declare its presence to an OLT CT by providing a globally unique identifier of the ONU (i.e., a serial number, a media access control (MAC) address, or the like depending on a standard), and can wait for assignment of an ODN-specific logical identifier (ONU-ID).

Once the OLT CT assigns the logical ID to the ONU, the ONU can enter a ranging stage of the activation cycle. In the ranging stage, the ONU can be requested to perform one or more short upstream transmissions to allow the OLT CT to accurately measure a round-trip delay (e.g., a round-trip optical signal propagation time and a processing time) and to compute an equalization delay (e.g., extra time that the ONU can be required to delay transmission in order to compensate for differences in the round-trip propagation times between ONUs on the same ODN). Once the individual equalization delay is assigned to the ONU, the ONU can enter a regular operation stage, and can remain in the regular operation stage until the ONU is reset (e.g., by a user), is deactivated by the OLT CT, is disabled by the OLT CT, experiences a loss of connectivity to the OLT CT, or the like.

Once an OLT CT assigns respective equalization delays to the ONUs, the OLT CT can transmit grants to the ONUs. A grant can refer to a permission to use a designated time slot for upstream transmission. In this way, the ONUs can provide, to the OLT CT and based on respective grants, upstream bursts that are received serially by the OLT CT, such as in a non-overlapping and non-interfering manner (e.g., in association with a designated time slot of the ONU). The OLT CT computes and transmits the start times and grant sizes to the ONUs periodically, for example, every 125 microseconds.

In some cases, due to design or manufacturing flaws, software or hardware failure, environmental factors, malicious intent, or other external factors, an ONU may exhibit behavior that is inconsistent with the protocol requirements and can cause interference and disruption of the PON operation. An ONU that transmits optical power up the ODN in violation of the protocol parameters is known as “rogue.” In such cases, the rogue ONU can cause interference and disruption of the PON system. For example, a rogue ONU that transmits upstream bursts outside of a designated time slot or generates continuous optical interference can cause performance issues by preventing the OLT CT 102 from receiving planned transmissions. This situation can cause service outages for other ONUs and/or render the entire PON system inoperable. An OLT in a PON system is required to effectively and efficiently detect, isolate, and mitigate rogue interference when it occurs. As described herein, rogue interference on a PON may be emulated so that the rogue detection, isolation, and mitigation capabilities of the PON system can be tested prior to system deployment in the field.

In some cases, the rogue optical interference cannot be traced back to a particular ONU, a situation referred to as non-discernible interference. For example, if the interference corrupts the header of the burst that specifies the sender or if the interference is not a formatted burst according to the protocol, such as continuous optical transmission, the interference is non-discernible.

Embodiments described herein enable a rogue ONU emulator device to receive, from an ONU (e.g., an ONU that is not associated with rogue behavior), upstream bursts, and alter the upstream bursts such that various non-discernable rogue behaviors are exhibited. In this way, implementations described herein enable isolation, detection, and/or mitigation procedures to be tested without requiring the actual presence of a rogue ONU on a PON system. By enabling such procedures to be tested, implementations described herein improve performance of a PON system, reduce an amount of time associated with PON system failures, reduce performance issues, etc.

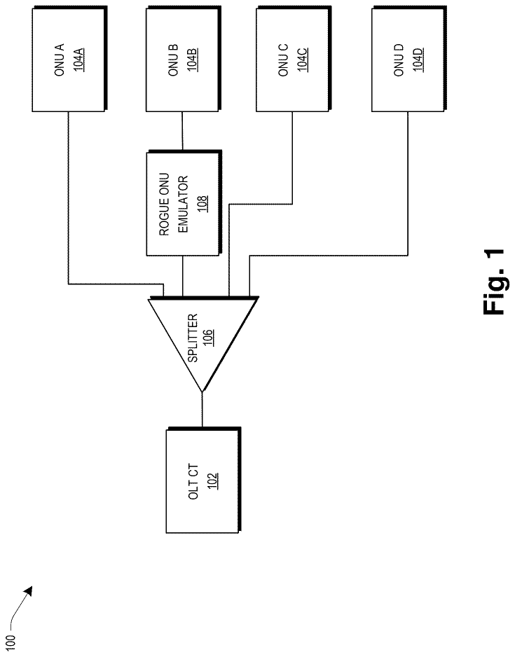

FIG. 1 is a diagram of an optical communication system 100, according to some embodiments. In some embodiments, the optical communication system 100 comprises an OLT CT 102 connected to multiple ONUs 104A, 104B, 104C, 104D by an optical splitter 106 and a rogue ONU emulator 108 connected between a selected ONU, such as the ONU 104B, and the OLT CT 102. The rogue ONU emulator 108 receives from the ONU 104B, an upstream burst that is directed toward the OLT CT 102. For example, assume that ONU 104B transmits an upstream burst in association with a designated time slot. Based on the different lengths of the fiber connections between the ONUs 104A, 104B, 104C and the OLT CT 102, the upstream bursts have different delays.

In some embodiments, the OLT CT 102 performs conversion (e.g. modulation/demodulation) between electrical signals used by service provider equipment and fiber optic signals used by the PON. The OLT CT 102 may coordinate multiplexing between conversion devices on the other end of the passive optical network (e.g., the ONUs 104A, 104B, 104C, 104D).

The ONUs 104A, 104B, 104C, 104D each include one or more devices capable of terminating a PON and providing an interface between the PON and a customer premises. In some implementations, an ONU 104A, 104B, 104C, 104D ONU 280 can provide multiple service interfaces for the customer (e.g., an interface for voice services, an interface for data services, an interface for television services, or the like). The ONUs 104A, 104B, 104C, 104D may provide, to the OLT CT 102 information using upstream optical signals. The ONUs 104A, 104B, 104C, 104D receive downstream optical signals provided by the OLT CT 102, and/or send the downstream optical signals to devices provided at the customer premises. In some implementations, each ONU 104A, 104B, 104C, 104D can choose a single wavelength channel on which to operate and can switch wavelength channels, if instructed by a respective OLT CT 102.

In some embodiments, the splitter 106 includes one or more devices capable of splitting an optical signal (e.g., broadcast or downstream optical signals provided by OLT CT 102) into multiple optical signals. For example, the splitter 106 may receive a single optical signal (e.g., a broadcast or downstream optical signal), split the optical signal into multiple optical signals, and provide the multiple optical signals to one or more of the ONUs 104A, 104B, 104C, 104D. In some embodiments, the splitter 106 may receive one or more optical signals (e.g., upstream optical signals) from the ONUs 104A, 104B, 104C, 104D (e.g., one from each ONU 104A, 104B, 104C, 104D), and pass the one or more optical signals as a single optical signal to the OLT CT 102.

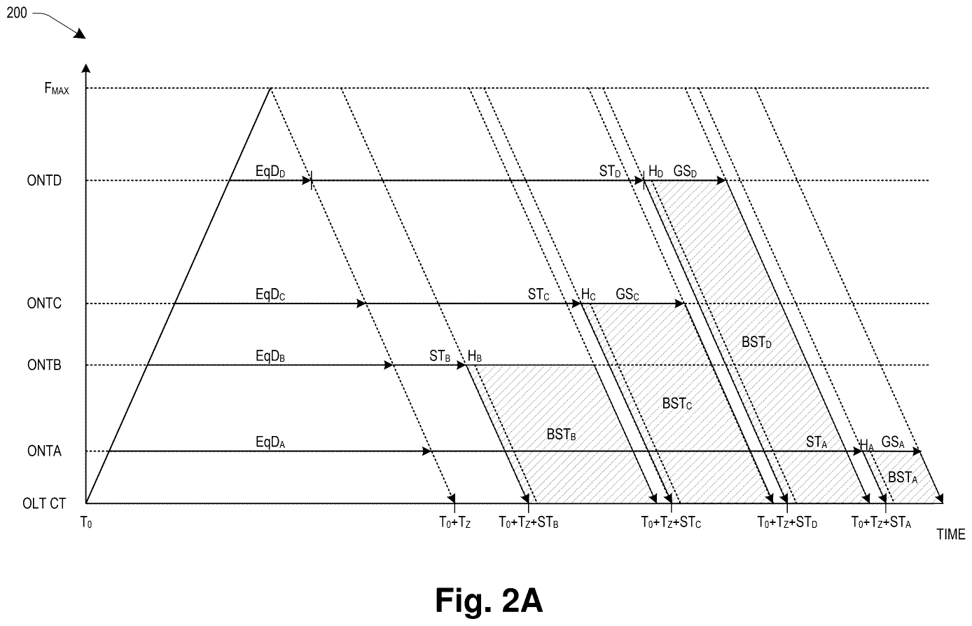

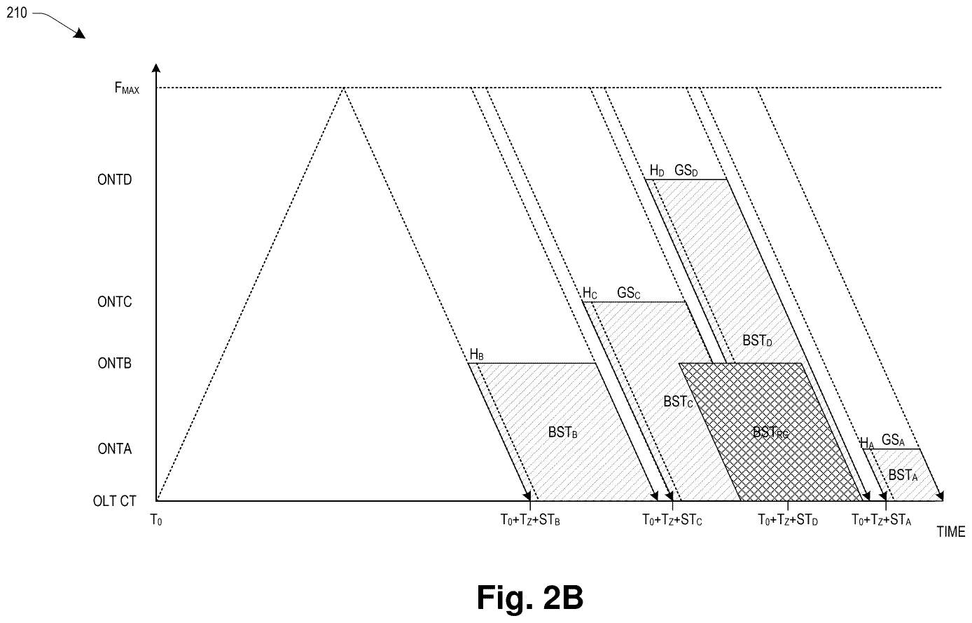

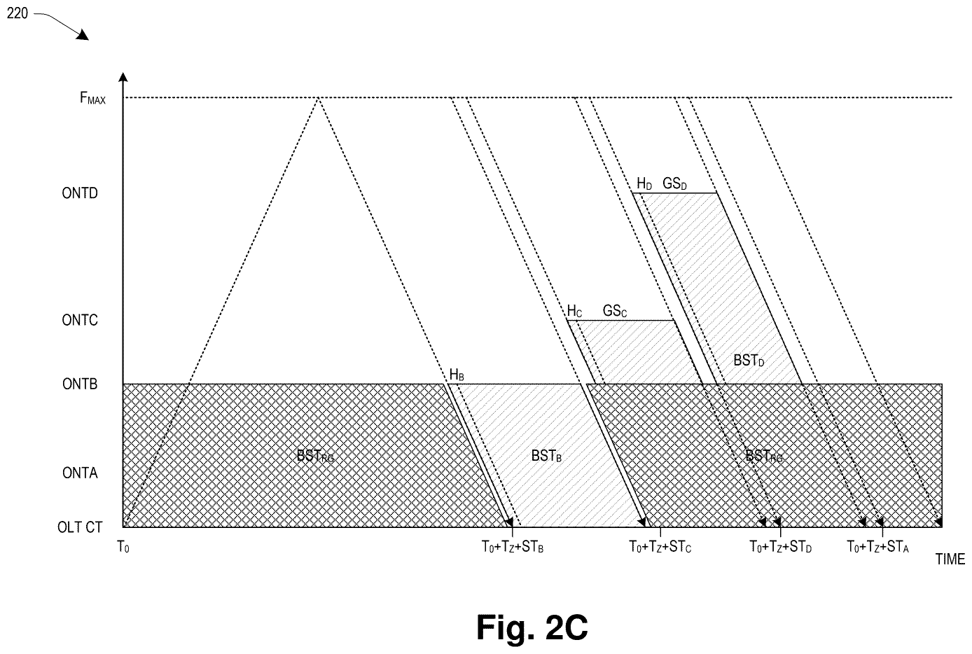

FIGS. 2A, 2B, and 2C are transmission timing diagrams 200, 210, 220 for the optical communication system 100, according to some embodiments. FIG. 2A shows a nominal transmission timing example. As illustrated in FIG. 2A, the OLT CT 102 determines an equalization delay (EqD_{A}, EqD_{B}, EqD_{C}, EqD_{D}) for each of the ONUs 104A, 104B, 104C, 104D that measures the delays associated with the different length of the optical fiber connections to the OLT CT 102. The ONU CT 102 may determine the equalization delay for a particular ONU 104A, 104B, 104C, 104D during an activation period when the ONU 104A, 104B, 104C, 104D attempts to join or rejoin the optical network. The OLT CT 102 uses the equalization delays to assign start times (ST_{A}, ST_{B}, ST_{C}, ST_{D}) and grant times (GS_{A}, GS_{B}, GS_{C}, GS_{D}) to each of the ONUs 104A, 104B, 104C, 104D to time-shift the upstream bursts (BST_{A}, BST_{B}, BST_{C}, BST_{D}) from the ONUs 104A, 104B, 104C, 104D to prevent overlap when received at the OLT CT (indicated by the OLT CT line of the timing diagram). The OLT CT 102 makes these assignments periodically at the start of a physical layer (PHY) frame, represented by T₀. The time T_{z} is the offset of the upstream PHY frame with respect to the downstream PHY frame, also referred to as the upstream frame offset or the “zero-distance equalization delay” since a hypothetical ONU co-located with the OLT CT 102 and thus having zero fiber distance would be assigned the equalization delay equal to T_{z}. Physically, T_{z} is the round-trip propagation time of the optical signal from the OLT CT 102 to a (virtual) reference point at the chosen equivalent equalization fiber distance and back to the OLT CT 102. For example, if the farthest away ONU 104A, 104B, 104C, 104D in the PON has a fiber distance of 20 km, the equalization distance can be approximately 28 km (or more). The difference between the equivalent equalization distance and the fiber distance of the farthest-away ONU 104A, 104B, 104C, 104D is due to finite signal processing time of the ONU 104A, 104B, 104C, 104D. F_{MAX} is the fiber distance of the equivalent equalization point. The process of round-trip optical signal propagation time measurement and equalization delay assignment may be referred to as ranging. In some embodiments, each burst (BST_{A}, BST_{B}, BST_{C}, BST_{D}) has an associated header (H_{A}, H_{B}, H_{C}, H_{D}) formatted according to the protocol of the optical communication system 100 that identifies the sender.

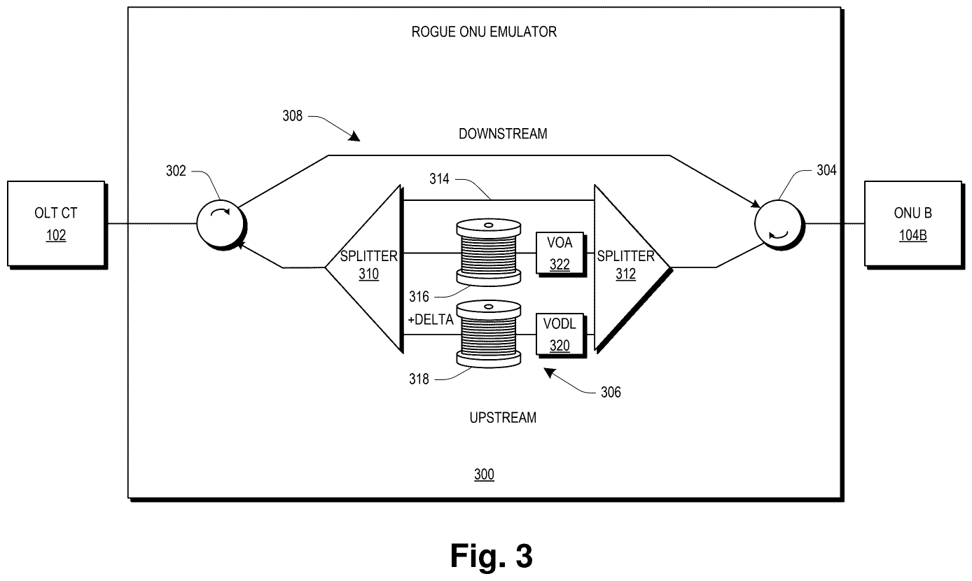

FIG. 3 is a diagram of a first example rogue optical network unit emulator 300, according to some embodiments. The rogue optical network unit emulator 300 may be the rogue optical network unit emulator 108 in FIG. 1. In some embodiments, the rogue optical network unit emulator 300 comprises signal separators 302, 304 that generate an upstream path 306 and a downstream path 308 from the optical communication channel (e.g., optical fiber) between the OLT CT 102 and the ONU 104B and splitters 310, 312 that selectively connect various optical components, such as a reference fiber 314 and delay fibers 316, 318, into the downstream path 308 to generate non-discernible interference. The signal separators 302, 304 may be optical circulators, semi-transparent mirrors, or some other optical device that can divide the upstream path 306 and the downstream path 308.

During the activation period for the ONU 104B, the splitters 310, 312 are connected by the single reference fiber 314 in the upstream path 306. The OLT CT 102 determines the equalization delay based on the length of the reference fiber 314 and generates start time and grant sizes as shown in FIG. 2A. After activation of the ONU 104B is completed, one or more additional branches, such as the delay fibers 316, 318 are added to the splitters 310, 312. In some embodiments, the rogue ONU emulator 300 generates non-discernible interference by shifting the burst (BSTB) from the ONU 104B to generate a rogue burst (BSTRG) by combining the outputs of the delay fibers 316, 318 as shown in FIG. 2B. The delay fiber 316 includes a fiber length different than the reference fiber 314 such that the start of the rogue burst (BSTRG) is shifted in time compared to the start of the normal burst (BSTB), causing the rogue burst (BSTRG) to interfere with one or more other bursts, such as the bursts (BSTB, BSTC) in FIG. 2B. The delay fiber 318 has a delay corresponding to the delay of the delay fiber 316 plus or minus a small delta value such that the outputs of the delay fibers 316, 318 overlap to obscure the header of the rogue burst (BSTRG). In some embodiments, the delta is set by configuring a variable optical delay line (VODL) 320 connected to the delay fiber 318 to provide a configurable delay. In some embodiments, a variable optical attenuator (VOA) 322 may be provided on one or both of the delay fibers 316, 318 to adjust the amplitude of the rogue burst (BSTRG). Hence, the rogue burst (BSTRG) represents non-discernible interference on the upstream path 306 that cannot be traced to a particular ONU 104A, 104B, 104C, 104D because of the obscurement of the header data.

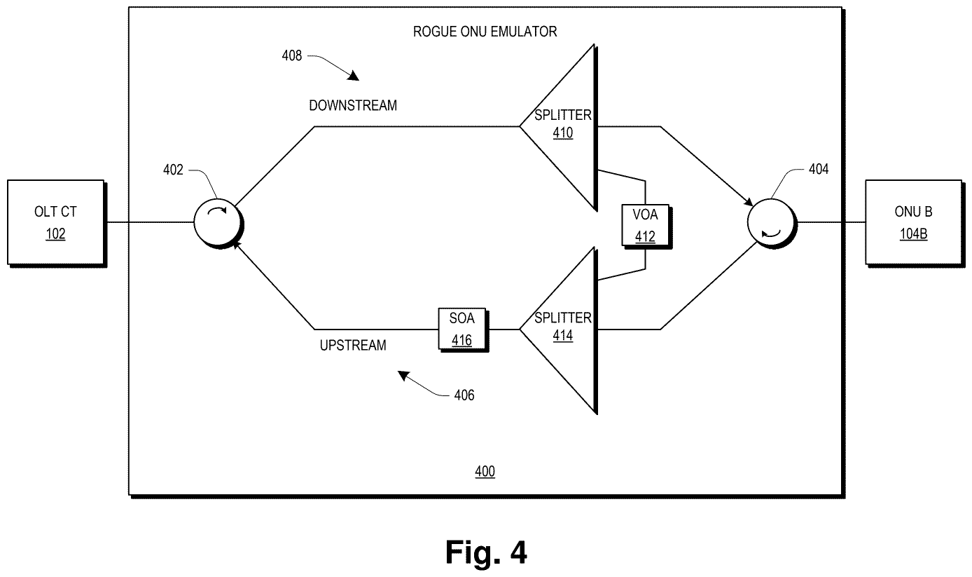

FIG. 4 is a diagram of a second example rogue optical network unit emulator 400, according to some embodiments. The rogue optical network unit emulator 400 may be the rogue optical network unit emulator 108 in FIG. 1. In some embodiments, the rogue optical network unit emulator 400 comprises signal separators 402, 404 that generate an upstream path 406 and a downstream path 408 from the optical communication channel between the OLT CT 102 and the ONU 104B. A splitter 410 connects an optical signal on the downstream path 408 to a VOA 412 to generate an interference signal and a splitter 416 connects the interference signal output by the VOA 412 to the upstream path 406 to generate non-discernible continuous interference. The downstream signal is formatted according to the PON protocol and transmitted by the by the OLT CT 102, but is seen as noise when received by the OLT CT 102 on the upstream path 406. An optical amplifier 416 may be provided in the upstream path 406 to control the amplitude of the non-discernible continuous interference signal. The signal separators 402, 404 may be optical circulators, semi-transparent mirrors, or some other optical device that can divide the upstream path 406 and the downstream path 408.

During the activation period for the ONU 104B, the splitter 410 is not connected to the splitter 414 to allow the OLT CT 102 to determine the equalization delay as shown in FIG. 2A. After activation of the ONU 102B, a connection between the splitters 410, 414 is added to inject a continuous downstream signal into the upstream path. In some embodiments, the rogue ONU emulator 400 generates non-discernible continuous interference rogue bursts (BSTRG) by injecting a downstream signal on the upstream path 406 as shown in FIG. 2C. Hence, the rogue burst (BSTRG) represents non-discernible continuous interference.

The rogue ONU emulators 300, 400 enable procedures (e.g., detection, isolation, and/or mitigation procedures) to be tested by the OLT CT 102 by emulating rogue ONU behavior on a PON system. Such testing is facilitated without requiring an ONU 104A, 104B, 104C, 104D to actually exhibit rogue behavior. The rogue ONU emulators 300, 400 includes one or more devices capable of emulating rogue ONU behavior while enabling downstream and upstream connectivity between the OLT CT 102 and the ONU 104B to be maintained.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
dividing an optical communication channel to separate an upstream path and a downstream path;
generating an interference signal to emulate rogue transmission behavior on the upstream path by connecting the downstream path to the upstream path; and
undividing the optical communication channel, after generating the interference signal, by recombining the downstream path and the upstream path.

2. The method of claim 1, comprising:
testing a mitigation procedure of an optical line terminal channel termination connected to the optical communication channel based on the interference signal.

3. The method of claim 2, comprising:
attenuating the interference signal.

4. The method of claim 1, comprising:
amplifying a downstream signal on the downstream path after generating the interference signal.

5. The method of claim 1, wherein:
dividing the optical communication channel comprises:
dividing the optical communication channel in at least one of an optical circulator or a semi-transparent mirror.

6. The method of claim 1, comprising:
performing a channel equalization process during a first interval, wherein:
connecting the downstream path to the upstream path comprises:
connecting the downstream path to the upstream path to generate the interference signal during a second interval after the first interval.

7. The method of claim 1, comprising:
receiving a burst signal from an optical network unit connected to the optical communication channel; and
combining the burst signal and the interference signal on the upstream path.

8. The method of claim 1, comprising:
receiving a downstream signal from an optical line terminal channel termination connected to the optical communication channel; and
generating the interference signal based on the downstream signal.

9. A device, comprising:
a first signal separator connected to an optical communication channel to generate an upstream path and a downstream path;
a first splitter on the downstream path;
a second splitter on the upstream path and connected to the first splitter; and
a second signal separator connected to the optical communication channel to recombine the upstream path and the downstream path, wherein:
the first splitter and the second splitter are configured to connect the downstream path to the upstream path to generate an interference signal to emulate rogue transmission behavior on the upstream path.

10. The device of claim 9, comprising:
a variable optical attenuator connected to first splitter to attenuate the interference signal.

11. The device of claim 9, comprising:
an optical amplifier connected to an output of the second splitter.

12. The device of claim 9, wherein:
the first signal separator comprises at least one of an optical circulator or a semi-transparent mirror.

13. The device of claim 9, wherein:
the first splitter and the second splitter are configured to connect the downstream path to the upstream path to generate the interference signal during an interval for testing rouge mitigation methodology.

14. The device of claim 9, wherein:
the first splitter is configured to:
receive a burst signal from an optical network unit connected to the optical communication channel; and
combine the burst signal and the interference signal on the upstream path.

15. The device of claim 9, wherein:
the first splitter is configured to:
receive an upstream signal from an optical line terminal channel termination connected to the optical communication channel; and
generate the interference signal based on the upstream signal.

16. A device, comprising:
a first signal separator connected to an optical communication channel to generate an upstream path and a downstream path;
a first splitter on the upstream path;
a second splitter on the upstream path;
a first delay fiber connected to the first splitter and the second splitter;
a second delay fiber connected to the first splitter and the second splitter;
a variable optical delay line connected to the second delay fiber; and
a second signal separator connected to the optical communication channel to recombine the upstream path and the downstream path, wherein:
the first splitter and the second splitter are configured to connect the first delay fiber and the second delay fiber to the upstream path to generate an interference signal to emulate rogue transmission behavior on the upstream path.

17. The device of claim 16, comprising:
a variable optical attenuator connected to first delay fiber.

18. The device of claim 16, wherein:
the first signal separator comprises at least one of an optical circulator or a semi-transparent mirror.

19. The device of claim 16, comprising:
a reference fiber connected between the first splitter and the second splitter, wherein:
the first splitter and the second splitter are configured to connect the reference fiber to the upstream path to perform a channel equalization process during a first interval; and
the first splitter and the second splitter are configured to connect the first delay fiber and the second delay fiber to the upstream path during a second interval after the first interval.

20. The device of claim 19, wherein:
the first splitter is configured to:
receive a burst signal from an optical network unit connected to the optical communication channel; and
route the burst signal to the first delay fiber and the second delay fiber to generate the interference signal.
